(19) United States
(12) Patent Application Publication
(10) Pub. No.: US 2017/0108996 A1
(43) Pub. Date: Apr. 20, 2017

(54) Method and Apparatus for Dynamically Organizing a Tree Structure

(71) Applicant: ADP, LLC, Roseland, NJ (US)

(72) Inventors: Edwin Charbel Baladi, New York, NY (US); Agatha Kurjanowicz, Ottawa (CA); David Philander Derby, New York, NY (US); Benjamin John Dziuba, New York, NY (US); Nick Heasman, New York, NY (US); Omar Scott, Brooklyn, NY (US)

(21) Appl. No.: 14/883,091

(22) Filed: Oct. 14, 2015

(51) Int. Cl. G06F 3/0482; G06F 3/0484

(52) U.S. Cl. CPC G06F 3/0482; G06F 3/04842

(57) ABSTRACT

A method and apparatus for visually presenting a hierarchical organization for an entity. A tree structure that represents the hierarchical organization for the entity is displayed by a computer system in a graphical user interface on a display system. A sequence of user inputs is received by a computer system through the graphical user interface. A plurality of levels of the tree structure in the graphical user interface is transformed, by the computer system, based on the sequence of user inputs such that a series of direct linkages from a topmost level of the plurality of levels to a bottommost level of the plurality of levels is aligned with a vertical alignment axis.

### BACKGROUND INFORMATION

1. Field

The present disclosure relates generally to managing an entity and, in particular, to managing an organization of positions associated with an entity. Still more particularly, the present disclosure relates to a method and apparatus for improving the ease with which a user can comprehend the relationships between different levels of positions in a hierarchical organization for an entity.

2. Background

An entity may take the form of a business entity, an organization, an athletic organization, an educational organization, a committee, a governmental organization, a firm, or some other type of entity. In some cases, an entity may be comprised of tens to hundreds of thousands of persons that hold various positions associated with that entity.

As one example, in a business entity, such as a corporation, one person may hold the position of chief executive officer (CEO). The chief executive officer may oversee a group of executive officers. Each executive officer may oversee a group of managers. Each manager may supervise a group of project leaders. Each project leader may supervise a group of project members. In this manner, the positions associated with this business entity may form a hierarchical organization.

In some cases, the hierarchical organization for an entity may be very complex, especially when the entity includes hundreds to thousands of positions or more. Tree structures are oftentimes used to represent the hierarchical organization of an entity in a graphical form. However, some currently available methods for visually presenting these tree structures to persons may make it difficult for these persons to understand the hierarchical nature of the entity as quickly and easily as desired.

Further, some currently available methods for visually presenting tree structures may not allow a user to comprehend the relationships between different levels of positions in a hierarchical organization for an entity as quickly and as easily as desired. Still further, some currently available methods for visually presenting tree structures may not allow a user to graphically navigate through the hierarchical organization of an entity as quickly and easily as desired. Therefore, it would be desirable to have a method and apparatus that take into account at least some of the issues discussed above, as well as other possible issues.

### SUMMARY

In one illustrative embodiment, a method for visually presenting a hierarchical organization for an entity is provided. A tree structure that includes a number of levels of the hierarchical organization for the entity is displayed by a computer system in a graphical user interface on a display system. A user input that selects a node of interest from a plurality of nodes within a selected level of the number of levels of the hierarchical organization is received by the computer system. The node of interest and at least one other node in the plurality of nodes in the selected level are moved, by the computer system, relative to a horizontal axis to align the node of interest with a vertical alignment axis in the graphical user interface.

In another illustrative embodiment, a method for visually presenting a hierarchical organization for an entity is provided. A tree structure that represents the hierarchical organization for the entity is displayed by a computer system in a graphical user interface on a display system. A sequence of user inputs is received by a computer system through the graphical user interface. A plurality of levels of the tree structure in the graphical user interface is transformed, by the computer system, based on the sequence of user inputs such that a series of direct linkages from a topmost level of the plurality of levels to a bottommost level of the plurality of levels is aligned with a vertical alignment axis.

In yet another illustrative embodiment, an apparatus comprises a display system and a computer system. The display system displays a graphical user interface. The computer system displays a tree structure that includes a number of levels of a hierarchical organization for an entity in the graphical user interface on the display system. The computer system receives a user input that selects a node of interest from a plurality of nodes in a selected level of the number of levels of the hierarchical organization through the graphical user interface. The computer system moves the node of interest and at least one other node in the plurality of nodes in the selected level relative to a horizontal axis to align the node of interest with a vertical alignment axis in the graphical user interface.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an entity management system in the form of a block diagram in accordance with an illustrative embodiment;

FIG. 2 is an illustration of a graphical user interface in accordance with an illustrative embodiment;

FIG. 3 is an illustration of a graphical user interface in accordance with an illustrative embodiment;

FIG. 4 is an illustration of a graphical user interface in accordance with an illustrative embodiment;

FIG. 5 is an illustration of a graphical user interface in accordance with an illustrative embodiment;

FIG. 6 is an illustration of a graphical user interface in accordance with an illustrative embodiment;

FIG. 7 is an illustration of a graphical user interface in accordance with an illustrative embodiment;

FIG. 8 is an illustration of a graphical user interface in accordance with an illustrative embodiment;

FIG. 9 is an illustration of a graphical user interface in accordance with an illustrative embodiment;

FIG. 10 is an illustration of a graphical user interface in accordance with an illustrative embodiment;

FIG. 11 is an illustration of a graphical user interface in accordance with an illustrative embodiment;

FIG. 12 is an illustration of a graphical user interface in accordance with an illustrative embodiment;

FIG. 13 is an illustration of a graphical user interface in accordance with an illustrative embodiment;

FIG. 14 is an illustration of a process for visually presenting a hierarchical organization for an entity in the form of a flowchart in accordance with an illustrative embodiment;

FIG. 15 is an illustration of a process for visually presenting a hierarchical organization for an entity in the form of a flowchart in accordance with an illustrative embodiment;

FIG. 16 is an illustration of a process for visually presenting a hierarchical organization for an entity in the form of a flowchart in accordance with an illustrative embodiment; and

FIG. 17 is an illustration of a data processing system in the form of a block diagram in accordance with an illustrative embodiment.

### DETAILED DESCRIPTION

The illustrative embodiments recognize and take into account different considerations. For example, the illustrative embodiments recognize and take into account that it may be desirable to have a method and apparatus for improving the ease and speed with which a user can comprehend the relationships between different levels of positions in a hierarchical organization for an entity.

Thus, the illustrative embodiments provide a method and apparatus for visually presenting the hierarchical organization of an entity. In one illustrative embodiment, a method for visually presenting a hierarchical organization for an entity is provided. A tree structure that represents the hierarchical organization for the entity is displayed by a computer system in a graphical user interface on a display system. A sequence of user inputs is received by a computer system through the graphical user interface. A plurality of levels of the tree structure in the graphical user interface is transformed, by the computer system, based on the sequence of user inputs such that a series of direct linkages from a topmost level of the plurality of levels to a bottommost level of the plurality of levels is aligned with a vertical alignment axis.

The method and apparatus for visually presenting a hierarchical organization for an entity provided by the illustrative embodiments may enable a user to understand the hierarchical nature of the entity quickly and easily. Further, the different illustrative embodiments may enable a user to quickly and easily comprehend the relationships between different levels of positions in a hierarchical organization for an entity. Still further, the different illustrative embodiments may enable a user to quickly and easily navigate through the hierarchical organization of an entity within a graphical user interface.

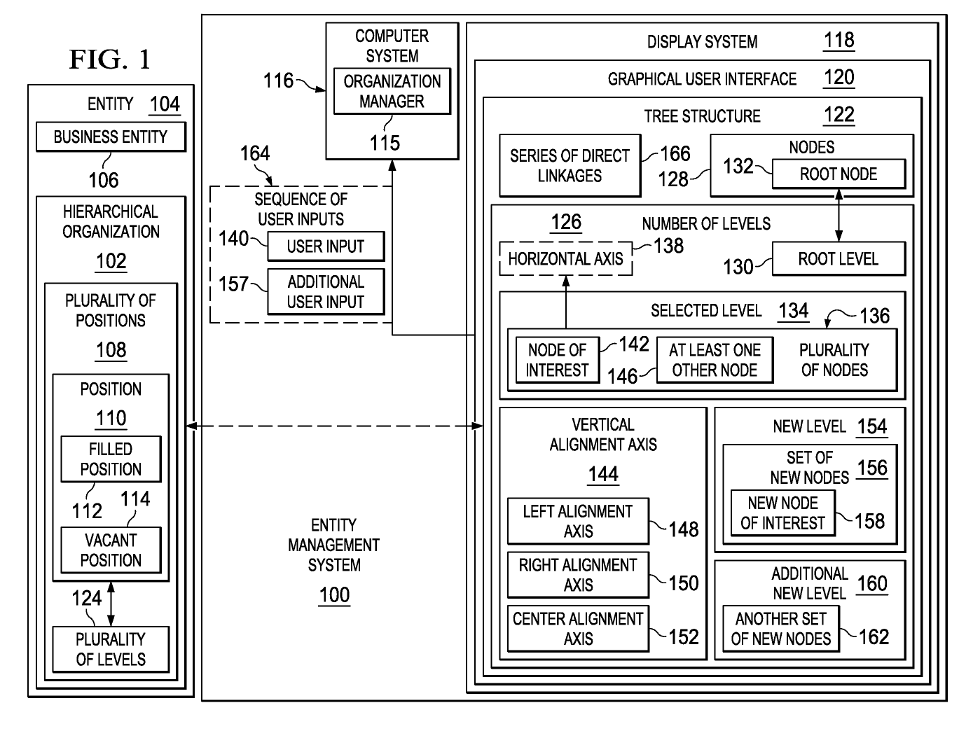

Referring now to the figures and, in particular, with reference to FIG. 1, an illustration of an entity management system is depicted in the form of a block diagram in accordance with an illustrative embodiment. In this illustrative example, entity management system 100 may be used to visually present hierarchical organization 102 for entity 104.

Entity 104 may take different forms. For example, without limitation, entity 104 may take the form of business entity 106. In other illustrative examples, entity 104 may take the form of an athletic organization, an educational organization, a committee, a governmental organization, a firm, a hospital, a charity organization, or some other type of entity.

Hierarchical organization 102 may be comprised of plurality of positions 108 that are associated with entity 104. Plurality of positions 108 may include different types of positions. Position 110 may be an example of one of plurality of positions 108. Position 110 may or may not be a distinct position.

Position 110 may take the form of, for example, without limitation, a chief executive officer, an executive officer, a financial manager, a group leader, a supervisor, a board director, a team member, a project manager, a project member, a technician, an employee, a volunteer, an independent contractor, a part-time employee, a full-time employee, or some other type of position.

Plurality of positions 108 may include positions that are distinct and positions that are not distinct. For example, without limitation, entity 104 may only include one position of chief executive officer. However, entity 104 may include multiple positions of project managers.

Position 110 may have the status of filled position 112 or vacant position 114. Filled position 112 may be a position that is currently being held by a person. Vacant position 114 may be a position that is not currently being held by any person. Depending on the implementation, the status of position 110 may change back and forth between filled position 112 and vacant position 114 over time.

In this illustrative example, entity management system 100 includes organization manager 115. Organization manager 115 may be implemented using software, hardware, firmware, or a combination thereof. When software is used, the operations performed by organization manager 115 may be implemented using, for example, without limitation, program code configured to run on a processor unit. When firmware is used, the operations performed by organization manager 115 may be implemented using, for example, without limitation, program code and data stored in persistent memory to run on a processor unit.

When hardware is employed, the hardware may include one or more circuits that operate to perform the operations performed by organization manager 115. Depending on the implementation, the hardware may take the form of a circuit system, an integrated circuit, an application specific integrated circuit (ASIC), a programmable logic device, or some other suitable type of hardware device configured to perform any number of operations.

A programmable logic device may be configured to perform certain operations. The device may be permanently configured to perform these operations or may be reconfigurable. A programmable logic device may take the form of, for example, without limitation, a programmable logic array, a programmable array logic, a field programmable logic array, a field programmable gate array, or some other type of programmable hardware device.

In one illustrative example, organization manager 115 is implemented within computer system 116. Computer system 116 may be comprised of one computer or multiple computers that are in communication with each other. In one illustrative example, the instructions, or code, for performing the steps that are performed by organization manager 115 may be stored in a memory of computer system 116 and implemented by one or more processors within computer system 116.

Entity management system 100 may also include display system 118. Depending on the implementation, display system 118 may be considered part of or separate from computer system 116. Display system 118 may be comprised of one or more display devices.

In this illustrative example, organization manager 115 visually presents hierarchical organization 102 for entity 104 in graphical user interface 120 on display system 118. In particular, organization manager 115 displays tree structure 122 that represents hierarchical organization 102 in graphical user interface 120.

As depicted, plurality of positions 108 that form hierarchical organization 102 may be organized in plurality of levels 124. At least one or more of plurality of levels 124 may be visually presented in graphical user interface 120 at a time. For example, without limitation, number of levels 126 may be displayed to form tree structure 122 in graphical user interface 120. As used herein, a “number of” items may include one or more items. In this manner, number of levels 126 may include one or more levels. In particular, number of levels 126 may include one or more levels from plurality of levels 124.

In this illustrative example, tree structure 122 includes nodes 128. Nodes 128 represent at least some portion of plurality of positions 108. In particular, each node in nodes 128 may represent a corresponding position in plurality of positions 108.

Number of levels 126 in tree structure 122 may include root level 130. Root level 130 may include a single node, such as root node 132. In other illustrative examples, root level 130 may include multiple root nodes.

Selected level 134 may be another example of one level in number of levels 126. Selected level 134 may be comprised of plurality of nodes 136. Plurality of nodes 136 may be displayed horizontally in tree structure 122 in graphical user interface 120. In particular, plurality of nodes 136 may be aligned substantially parallel to horizontal axis 138.

In one illustrative example, organization manager 115 receives user input 140 that selects node of interest 142 from plurality of nodes 136 in selected level 134. Node of interest 142 may be selected by a user, for example, because the user desires to view the one or more positions within plurality of positions 108 in hierarchical organization 102 for entity 104 that fall under the direction, supervision, management, or other purview of the position represented by node of interest 142.

In response to receiving user input 140, organization manager 115 determines whether node of interest 142 is aligned with vertical alignment axis 144. Vertical alignment axis 144 may take the form of left alignment axis 148, right alignment axis 150, or center alignment axis 152.

If node of interest 142 is not aligned with vertical alignment axis 144, organization manager 115 moves node of interest 142 and at least one other node 146 relative to horizontal axis 138 to align node of interest 142 with vertical alignment axis 144. For example, without limitation, node of interest 142 may be moved in a left direction along horizontal axis 138 to align node of interest 142 with left alignment axis 148. In another example, node of interest 142 may be moved in a right direction along horizontal axis 138 to align node of interest 142 with right alignment axis 150. Depending on the position of node of interest 142, node of interest 142 may be moved in either a left direction or a right direction along horizontal axis 138 to align node of interest 142 with center alignment axis 152.

In this illustrative example, once node of interest 142 is properly aligned with vertical alignment axis 144, organization manager 115 adds new level 154 to tree structure 122. In particular, organization manager 115 displays set of new nodes 156 horizontally in graphical user interface 120 to form new level 154 of tree structure 122. As used herein, a “set of” items includes one or more new items. In this manner, set of new nodes 156 includes one or more new nodes. Set of new nodes 156 may represent a set of positions in plurality of positions 108 of hierarchical organization 102 for entity 104 that fall under the direction, supervision, management, or some other purview of the position represented by node of interest 142.

New level 154 is directly linked to node of interest 142. In particular, organization manager 115 displays a direct linkage between each new node in set of new nodes 156 and node of interest 142 in graphical user interface 120.

In one illustrative example, organization manager 115 receives additional user input 157 that selects new node of interest 158 from set of new nodes 156 in new level 154 in tree structure 122. In response to receiving this selection of new node of interest 158, organization manager 115 determines whether or not new node of interest 158 is aligned with vertical alignment axis 144. If new node of interest 158 is not properly aligned with vertical alignment axis 144, organization manager 115 moves new node of interest 158 and at least one other new node in set of new nodes 156 to align new node of interest 158 with vertical alignment axis 144.

Once new node of interest 158 is aligned with vertical alignment axis 144, organization manager 115 adds additional new level 160 to tree structure 122. In particular, organization manager 115 displays another set of new nodes 162 horizontally in graphical user interface 120 to form additional new level 160 in tree structure 122. A direct linkage is displayed between each new node in another set of new nodes 162 and new node of interest 158.

In this manner, organization manager 115 may receive sequence of user inputs 164. At least one user input of sequence of user inputs 164 may select a particular node of interest in a particular level of tree structure 122. As nodes of interest are aligned with vertical alignment axis 144 based on sequence of user inputs 164 and new level 154 is added to tree structure 122, series of direct linkages 166 is created between a topmost level of the levels of tree structure 122 displayed in graphical user interface 120 to a bottommost level of the levels of tree structure 122. Each direct linkage in series of direct linkages 166 may be aligned with vertical alignment axis 144.

This alignment enables a user to more easily and more quickly understand the relationships between the different levels of tree structure 122 displayed in graphical user interface 120. Further, this type of alignment may enable a user to more easily and more quickly comprehend the different positions represented by the nodes linked by series of direct linkages 166 between the different levels of tree structure 122.

The illustration of entity management system 100 in FIG. 1 is not meant to imply physical or architectural limitations to the manner in which an illustrative embodiment may be implemented. Other components in addition to or in place of the ones illustrated may be used. Some components may be optional. Also, the blocks are presented to illustrate some functional components. One or more of these blocks may be combined, divided, or combined and divided into different blocks when implemented in an illustrative embodiment.

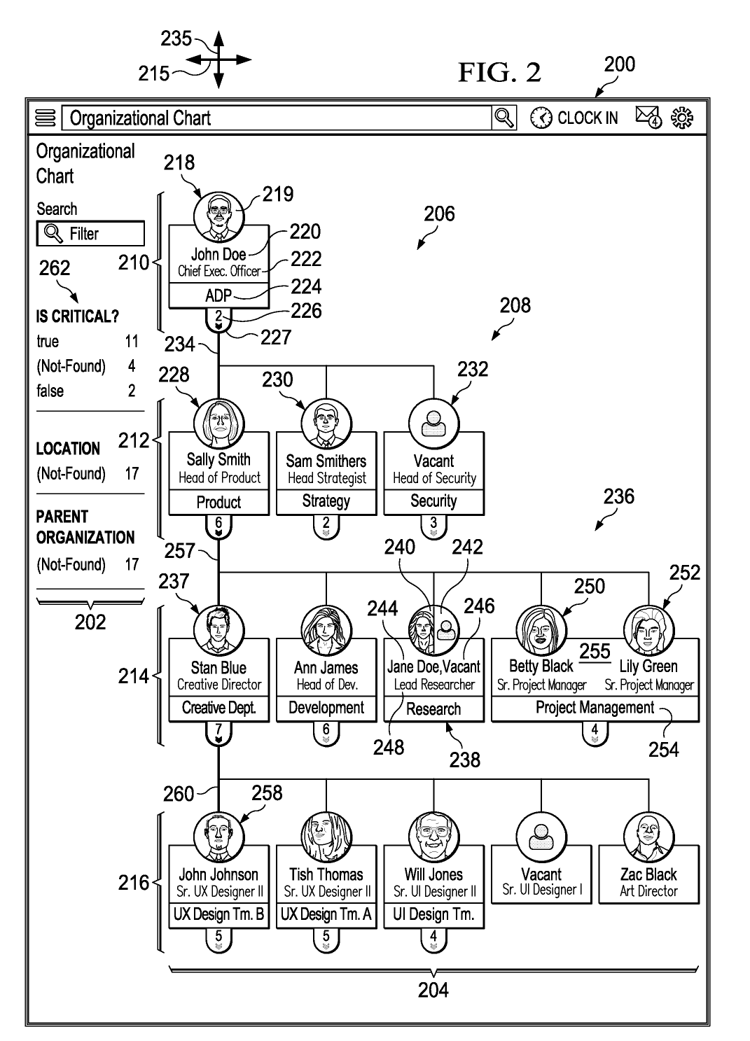

With reference now to FIGS. 2-9, illustrations of a graphical user interface are depicted in accordance with an illustrative embodiment. Turning now to FIG. 2, graphical user interface 200 may be an example of one implementation for graphical user interface 120 in FIG. 1.

As depicted, graphical user interface 200 includes summary area 202 and organization area 204. Tree structure 206 is displayed in organization area 204. Tree structure 206 may be an example of one implementation for tree structure 122 in FIG. 1. Tree structure 206 represents the hierarchical organization of a business entity, such as business entity 106 in FIG. 1.

In this illustrative example, tree structure 206 includes number of levels 208. Number of levels 208 may be an example of one implementation for number of levels 126 in FIG. 1. As depicted, number of levels 208 include root level 210, level 212, level 214, and level 216. Each of root level 210, level 212, level 214, and level 216 includes one or more nodes. Each of these nodes represents a position associated with the business entity and may be implemented in a similar manner.

Number of levels 208 are displayed horizontally. In particular, each level of number of levels 208 may be horizontally aligned with respect to horizontal axis 215. In other words, each level of number of levels 208 may be displayed substantially parallel to horizontal axis 215.

For example, without limitation, root level 210 includes root node 218. Root node 218 includes image 219, name 220, title 222, classification 224, and dependent number 226. Root node 218 represents a filled position associated with the business entity. In this illustrative example, root node 218 represents the chief executive officer for the business entity. Image 219 may capture the person that holds this current position. Name 220 identifies the name of this person. Title 222 identifies the position itself.

Classification 224 may identify, for example, without limitation, the business entity, a department, a project, a team, or other some other type of internal group within the business entity. Dependent number 226 identifies the number of positions that are under the supervision, direction, management, or some other purview of the position represented by root node 218. In this illustrative example, dependent number 226 is indicated on graphical control 227 that is selectable.

A selection of graphical control 227 causes level 212 to be displayed. A deselection of graphical control 227 causes level 212 and thereby, level 214 and level 216, to be removed from display in graphical user interface 200.

Each of the nodes in the other levels of tree structure 206 may be implemented in a manner similar to root node 218. In this illustrative example, level 212 includes node 228, node 230, and node 232. Node 228 represents the filled position of a head of a product group of the business entity. Node 230 represents the filled position of head strategist. Node 232 represents the vacant position of head of security.

Root node 218 is linked to level 212. In particular, root node 218 is linked to each of node 228, node 230, and node 232 in level 212. In this illustrative example, direct linkage 234 is displayed between root node 218 and node 228 of level 212. Direct linkage 234 is aligned along left alignment axis 235. Left alignment axis 235 is an example of one implementation for left alignment axis 148 in FIG. 1.

As depicted, level 214 includes plurality of nodes 236. Node 237 is an example of one of plurality of nodes 236. Node 238 is yet another example of one of plurality of nodes 236. In this illustrative example, node 238 includes image 240, null image 242, name 244, vacancy indicator 246, and title 248.

In this illustrative example, node 238 represents a position of a lead researcher, as indicated by title 248. The lead researcher may be under the direction of the head of the product group, who is represented by node 228. This position may be held by two persons. As depicted, node 238 does not include a dependency number, which indicates that the position of lead researcher represented by node 238 does not direct any lower level employees of the business entity.

Image 240 and null image 242 are shown joined to indicate that the single position of lead researcher may be filled by one person during a first shift period and another person during a second shift period. Image 240 captures the person identified by name 244 that works the first shift period. Null image 242 indicates that the position is vacant with respect to the second shift period. This vacancy is also indicated by vacancy indicator 246.

Node 250 and node 252 are other examples of nodes in plurality of nodes 236. Each of node 250 and node 252 represent a position of senior project manager in a project management group. This project management group is identified by classification 254 and graphical box 255 that joins both node 250 and node 252.

In this illustrative example, level 214 is linked to level 212. In particular, each node in plurality of nodes 236 is linked to node 228. Direct linkage 257 is displayed between node 228 and node 237. Direct linkage 257 is aligned along left alignment axis 235. Level 216 includes node 258 that is linked to node 237 of level 214 through direct linkage 260. Direct linkage 260 is aligned along left alignment axis 235. In this manner, direct linkage 234, direct linkage 257, and direct linkage 260 form a series of direct linkages that are aligned along left alignment axis 235.

Alignment of direct linkage 234, direct linkage 257, and direct linkage 260 along left alignment axis 235 enables a user to quickly and easily understand the relationships between the levels in number of levels 208 displayed in graphical user interface 200. In particular, a user may be able to quickly and easily identify the superior of the employees in a particular level by simply looking at the leftmost node of the level immediately above that particular level.

In this illustrative example, summary information 262 is displayed in summary area 202. Summary information 262 may include general information about the nodes displayed in tree structure 206 in graphical user interface 200.

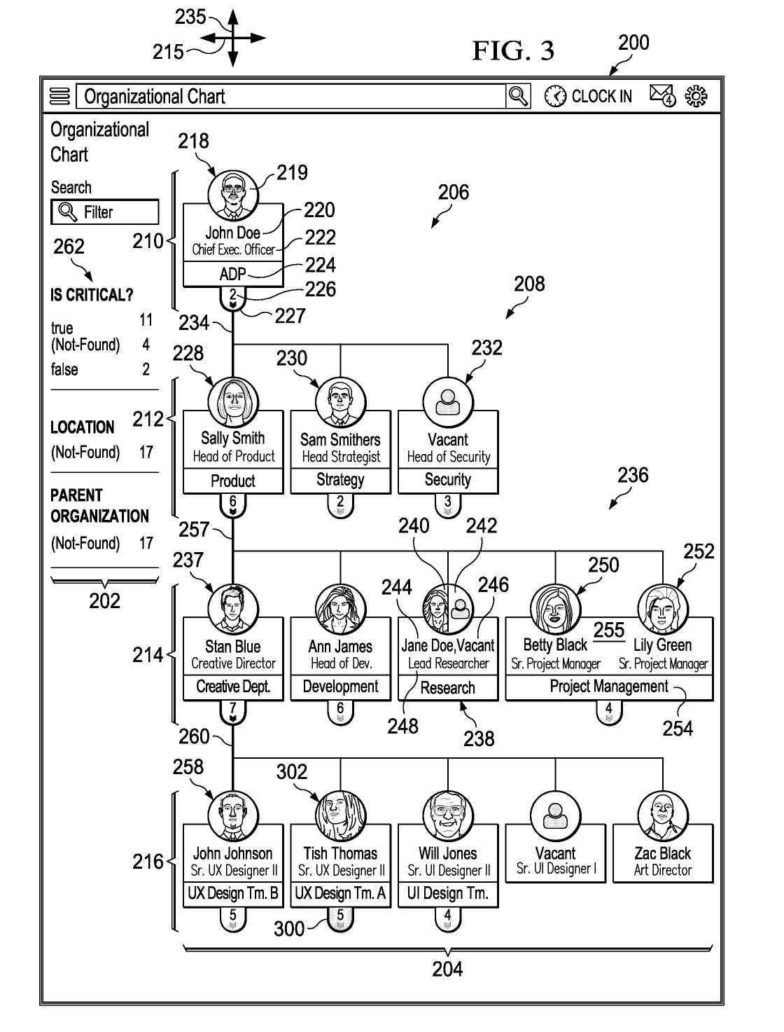

With reference now to FIG. 3, an illustration of a selection of a graphical control in graphical user interface 200 from FIG. 2 is depicted in accordance with an illustrative embodiment. In particular, user input that selects graphical control 300 of node 302 has been received through graphical user interface 200. As depicted, the selection of graphical control 300 causes a change in the appearance of node 302. In particular, graphical control 300 of node 302 is highlighted. This type of selection of graphical control 300 makes node 302 a node of interest.

In response to this selection of node 302 as a node of interest, an organization manager, such as organization manager 115 in FIG. 1, may determine that node 302 is not aligned with left alignment axis 235 in this illustrative example. In other words, node 302 is not the leftmost node in level 216 of tree structure 206. Consequently, the organization manager will move node 302 and at least one other node in level 216 horizontally relative to horizontal axis 215 to align node 302 with left alignment axis 235. Further, the organization manager will display a new level below level 216 to visually present the positions that are supervised or managed by the position represented by node 302.

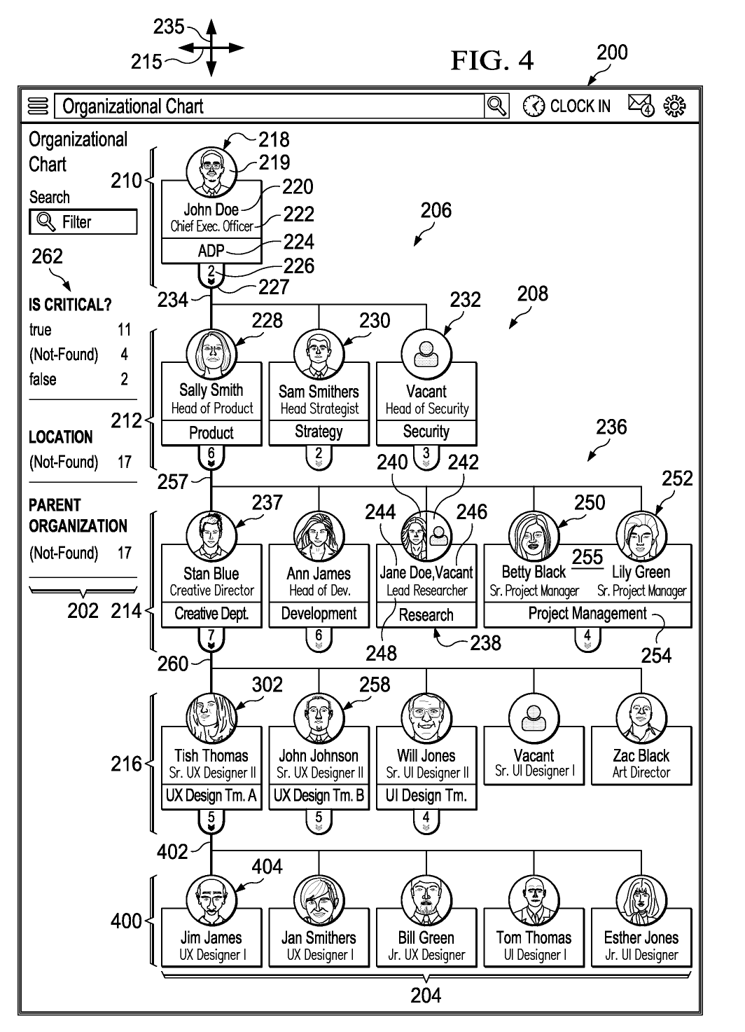

Turning now to FIG. 4, an illustration of a new level displayed in graphical user interface 200 from FIG. 3 is depicted in accordance with an illustrative embodiment. The selection of graphical control 300 of node 302 in FIG. 3 results in node 302 being aligned with left alignment axis 235.

In particular, node 258 has been moved horizontally to the right and node 302 has been moved horizontally to the left such that node 302 may be aligned with left alignment axis 235. In this illustrative example, node 258 and node 302 have effectively traded places within tree structure 206 displayed in graphical user interface 200.

Further, new level 400 is added to tree structure 206 in graphical user interface 200 below level 216. Direct linkage 402 is created between node 404 of new level 400 and node 302 of level 216.

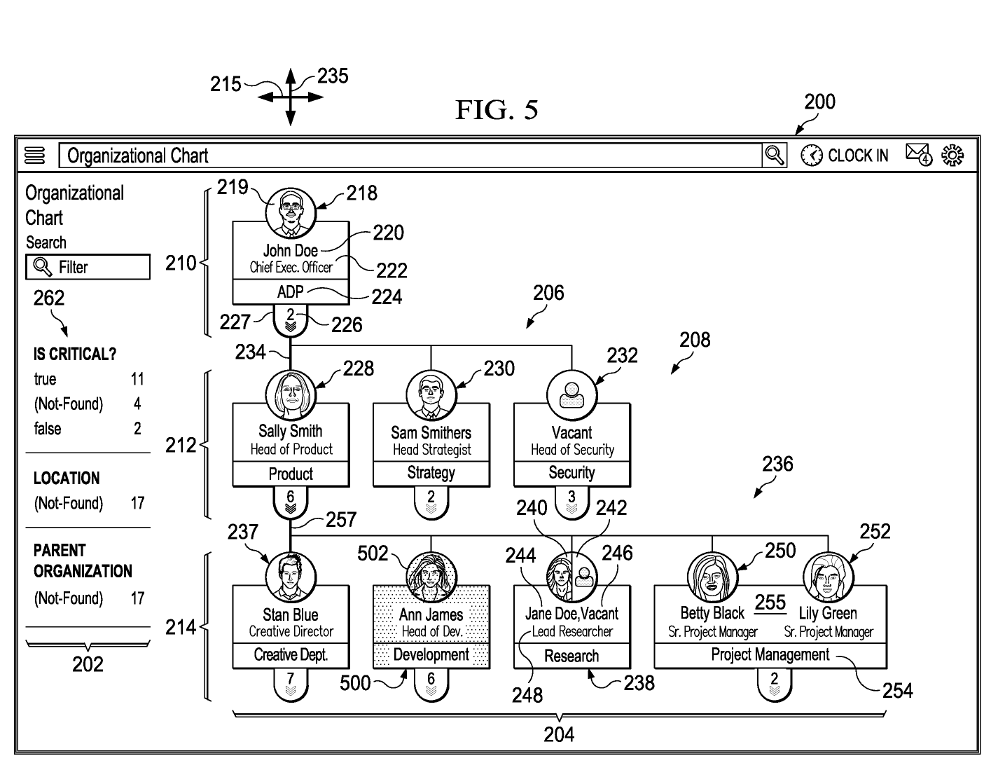

With reference now to FIG. 5, an illustration of root level 210, level 212, and level 214 of tree structure 206 from FIG. 2 is depicted in accordance with an illustrative embodiment. In this illustrative example, node 500 in level 214 is selected as a node of interest. In particular, image 502 of node 500 is selected through user input.

This selection causes node 500 to be highlighted in graphical user interface 200. Further, in response to the selection of node 500 by selecting image 502 of node 500, detailed information about the position represented by node 500 will be displayed in graphical user interface 200.

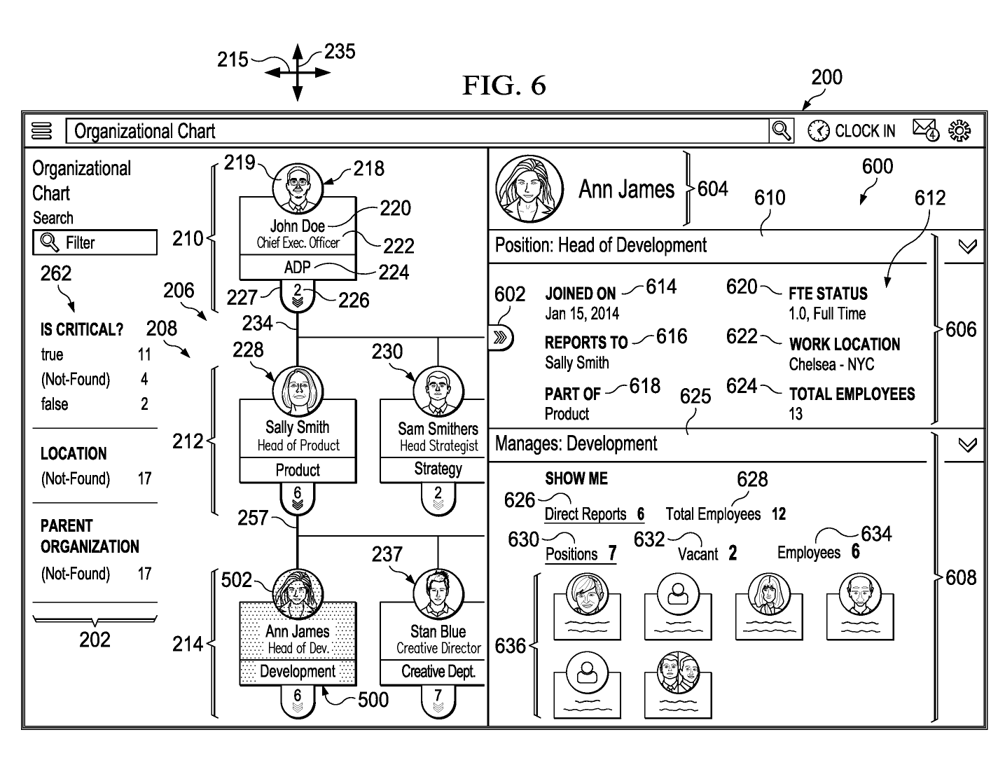

With reference now to FIG. 6, an illustration of detailed information for a position being displayed in graphical user interface 200 from FIG. 5 is depicted in accordance with an illustrative embodiment. In this illustrative example, the selection of node 500 in FIG. 5, through the selection of image 502 of node 500 in FIG. 5, results in detailed information 600 about the position represented by node 500 being displayed in graphical user interface 200. Detailed information 600 may be removed from or minimized within graphical user interface 200, depending on the implementation, by user input that selects graphical control 602.

As depicted, the selection of node 500 in FIG. 5 causes node 500 to become a node of interest. Consequently, node 500 has been moved horizontally relative to horizontal axis 215 to align node 500 with left alignment axis 235.

Detailed information 600 about the position represented by node 500 includes name 604, general position information 606, and subordinate information 608. Name 604 identifies the person that currently holds the position of head of development represented by node 500.

General position information 606 includes title 610 that identifies the position and plurality of details 612 about the position. As depicted in this illustrative example, plurality of details 612 may include, but are not limited to, join date 614, reports to position 616, superior level 618, employment status 620, work location 622, and total employees 624.

In this illustrative example, join date 614 is the date on which the person holding the position joined the business entity. Reports to position 616 is the position to which the head of development reports, which is the position of head of product represented by node 228 in this illustrative example. Superior level 618 identifies the group to which the position reports or under which the position belongs.

Employment status 620 may identify, for example, without limitation, whether the position is a full-time position, a part-time position, or some other type of position. Work location 622 identifies the location in which the person holding the position works. Total employees 624 identifies the number of employees that report to the person holding the position of head of development.

In this illustrative example, subordinate information 608 includes information about the employees that report to the head of development position. In this illustrative example, subordinate information 608 includes, but is not limited to, classification 625, direct reports 626, total employees 628, total positions 630, vacant positions 632, filled positions 634, and images 636.

Classification 625 identifies the group that the head of development manages. Direct reports 626 identifies the number of filled positions that currently, directly report to the head of development position. Total employees 628 identifies the number of employees under the purview of the head of development position, which may include persons who indirectly report to the head of development position.

Total positions 630 identifies the total number of positions that directly report to the head of development position. Vacant position 632 identifies the number of vacant positions under the direction of the head of development. Filled positions 634 identifies the number of filled positions under the direction of the head of development. Images 636 represent the total number of positions that directly report to the head of development position.

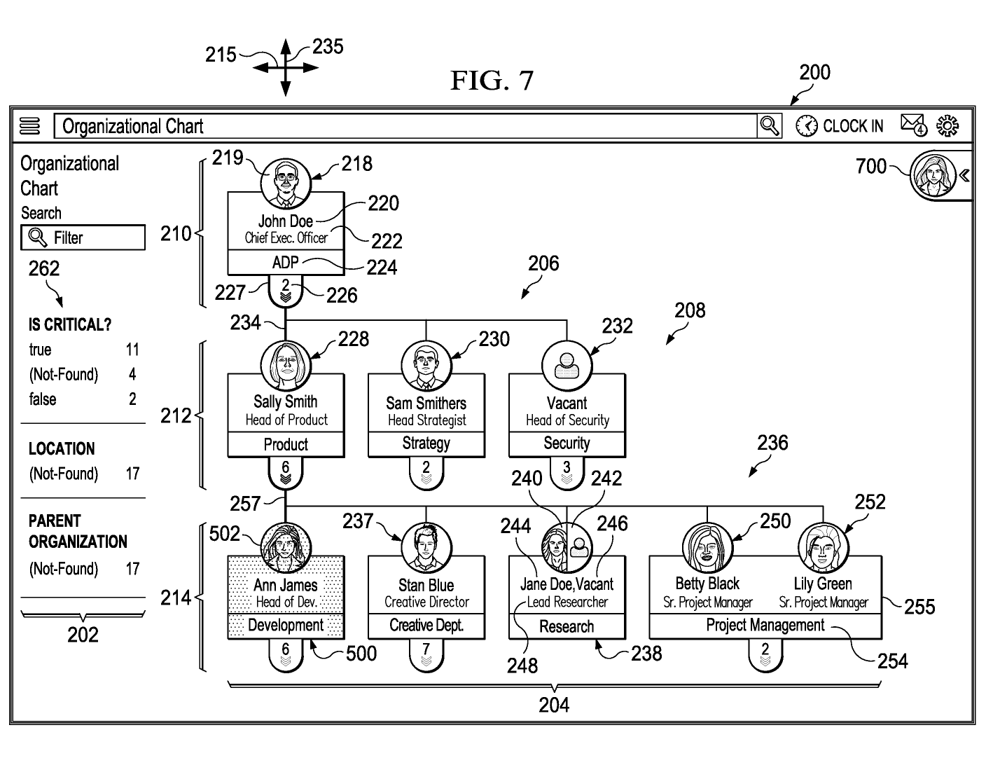

With reference now to FIG. 7, an illustration of graphical user interface 200 from FIG. 2 is depicted in accordance with an illustrative embodiment. In this illustrative example, detailed information 600 from FIG. 6 has been minimized within graphical user interface 200. In particular, a selection of graphical control 602 in FIG. 6 has caused detailed information 600 in FIG. 6 to be minimized to just graphical feature 700. A selection of graphical feature 700 will cause detailed information 600 from FIG. 6 to be displayed, once again, in graphical user interface 200.

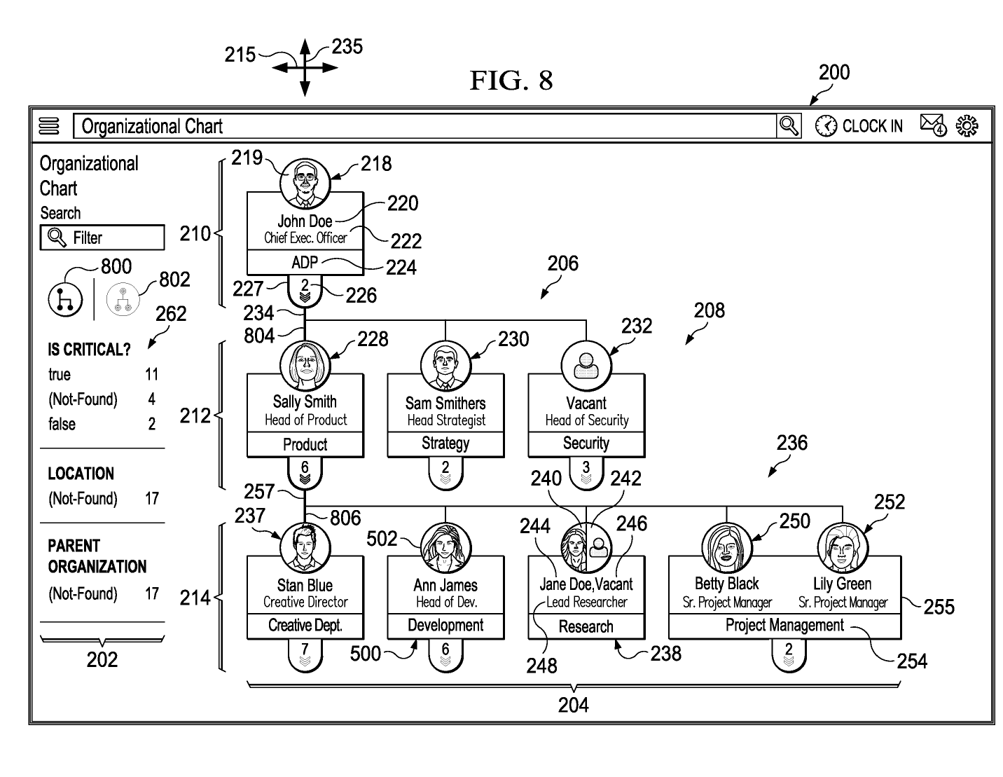

With reference now to FIG. 8, an illustration of graphical user interface 200 from FIG. 7 is depicted in accordance with an illustrative embodiment. In this illustrative example, graphical user interface 200 may include left alignment control 800 and center alignment control 802. As depicted, left alignment control 800 has been selected.

With left alignment control 800 selected, tree structure 206 is displayed such that the series of direct linkages between the various levels of tree structure 206 are aligned along left alignment axis 235. However, a user may select center alignment control 802 to transform the display of tree structure 206 such that the series of direct linkages are aligned along a center alignment axis (not shown in this illustrative example).

Direct linkage 234 has been emphasized in graphical user interface 200 with graphical feature 804. Direct linkage 257 has been emphasized in graphical user interface 200 with graphical feature 806. Graphical feature 804 and graphical feature 806 are bolded lines in this illustrative example.

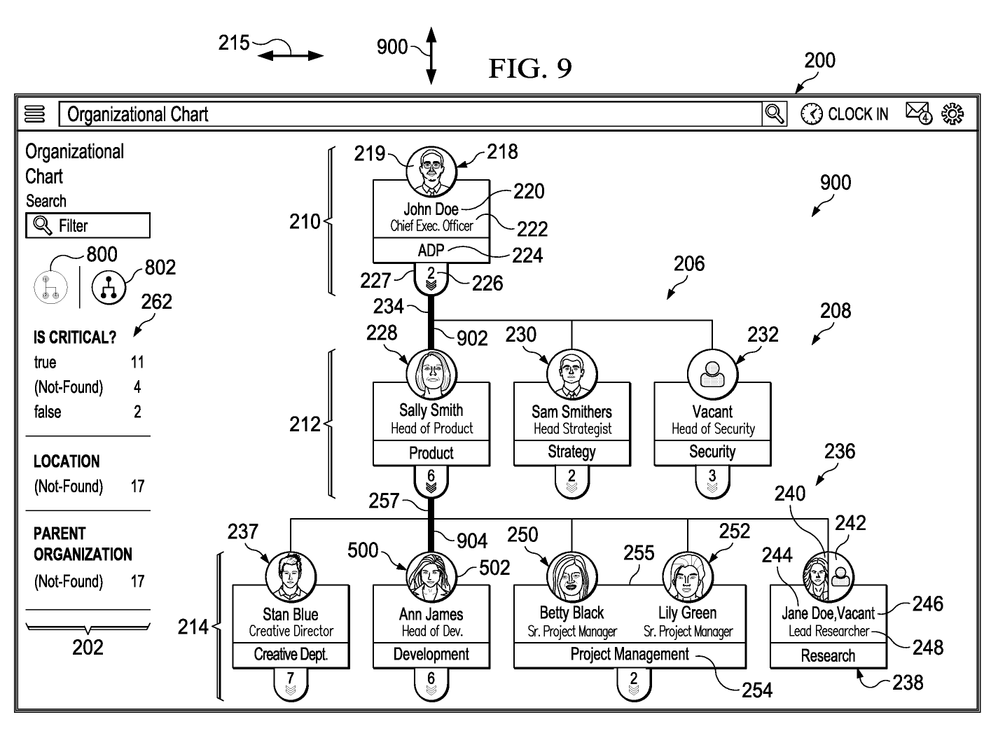

With reference now to FIG. 9, an illustration of graphical user interface 200 from FIG. 8 is depicted in accordance with an illustrative embodiment. In this illustrative example, user input has been received that selects center alignment control 802. This selection causes tree structure 206 in FIG. 8 to be transformed such that the series of direct linkages between the levels of tree structure 206 are aligned with center alignment axis 900. Center alignment axis 900 is an axis that lies vertically along the horizontal center of tree structure 206.

In this manner, left alignment control 800 and center alignment control 802 enable a user to determine the manner in which tree structure 206 is to be visually presented in graphical user interface 200. The alignment of the series of direct linkages between the levels of tree structure 206 along left alignment axis 235 or center alignment axis 900 allows a user to easily and quickly grasp the relationships between the positions of these different levels.

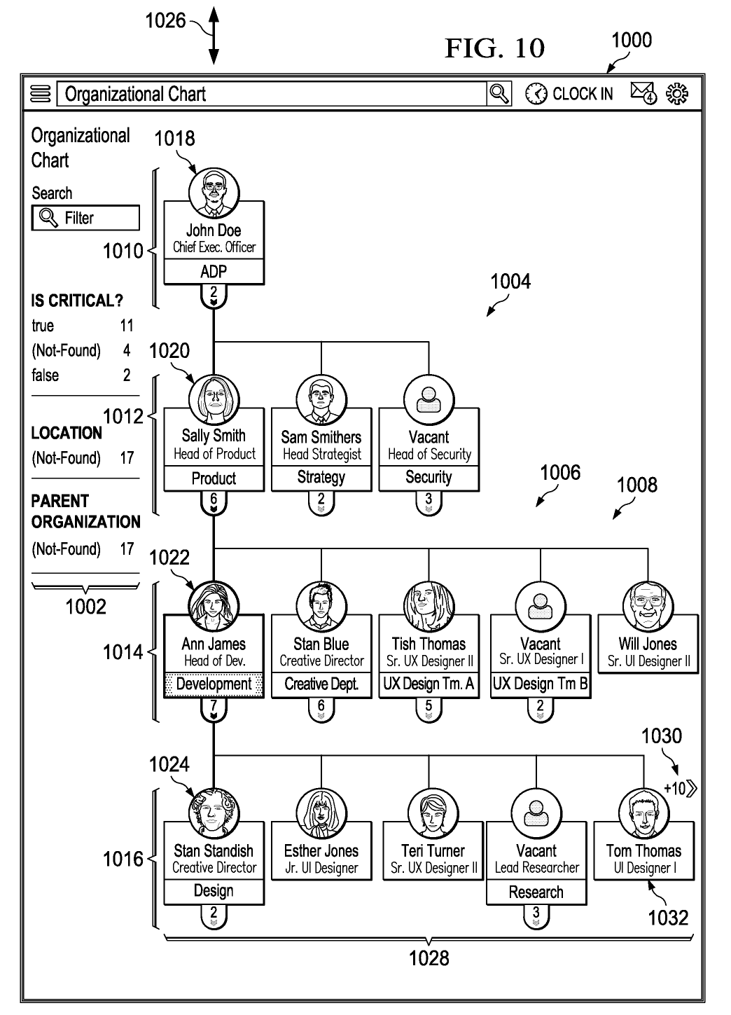

With reference now to FIGS. 10-13, illustrations of another graphical user interface are depicted in accordance with an illustrative embodiment. Turning now to FIG. 10, graphical user interface 1000 is another example of one implementation for graphical user interface 120 in FIG. 1.

Graphical user interface 1000 includes summary area 1002 and organization area 1004. Organization area 1004 visually presents tree structure 1006 that includes number of levels 1008. Tree structure 1006 may be an example of one implementation for tree structure 122 in FIG. 1. Tree structure 1006 represents the hierarchical organization of a business entity.

In this illustrative example, number of levels 1008 include root level 1010, level 1012, level 1014, and level 1016. Root node 1018 in root level 1010 is directly linked to node 1020 of level 1012. Node 1020 is directly linked to node 1022 of level 1014. Node 1022 is directly linked to node 1024 of level 1016. These direct linkages visually represent a series of relationships between the various positions in the different levels. These direct linkages are aligned along left alignment axis 1026, which is an example of one implementation for left alignment axis 148 in FIG. 1.

As depicted, level 1016 includes set of nodes 1028. Set of nodes 1028 may include only a portion of the total number of nodes that belong to the corresponding level in the hierarchical organization of the business entity, as indicated by expander control 1030. A user may select expander control 1030 to transform level 1016 such that a different set of nodes is displayed in level 1016. Expander control 1030 identifies that level 1016 includes ten other nodes not displayed in graphical user interface 1000. Node 1032 is the rightmost node displayed in level 1016.

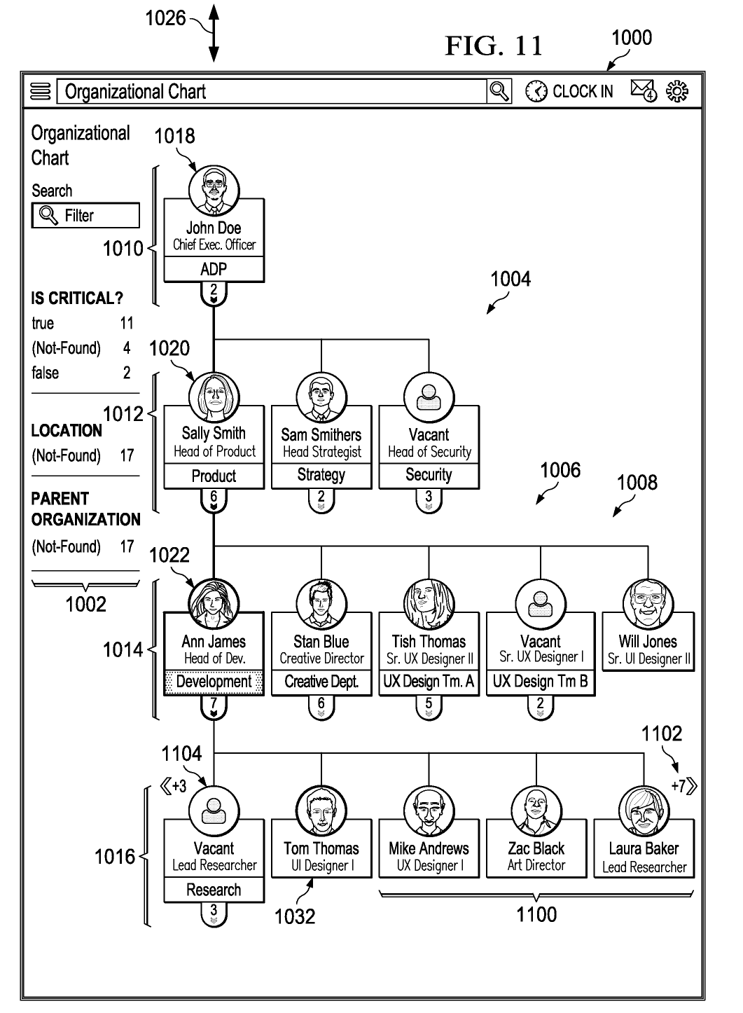

With reference now to FIG. 11, an illustration of graphical user interface 1000 from FIG. 10 is depicted in accordance with an illustrative embodiment. In this illustrative example, expander control 1030 in FIG. 10 has been selected such that the nodes displayed in level 1016 of tree structure 1006 have been transformed.

As depicted, the nodes in level 1016 from FIG. 10 have shifted horizontally to the left such that the position of node 1032 has been moved to the left. New nodes 1100 are displayed in level 1016. Right expander control 1102 indicates that level 1016 includes six other nodes not displayed in graphical user interface 1000. Left expander control 1104 indicates that level 1016 includes four other nodes not displayed in graphical user interface 1000.

In this illustrative example, a user may enter user input that selects node 1032. This selection causes node 1032 to be highlighted. Further, in response to the selection of node 1032, node 1032 will be moved and aligned with left alignment axis 1026.

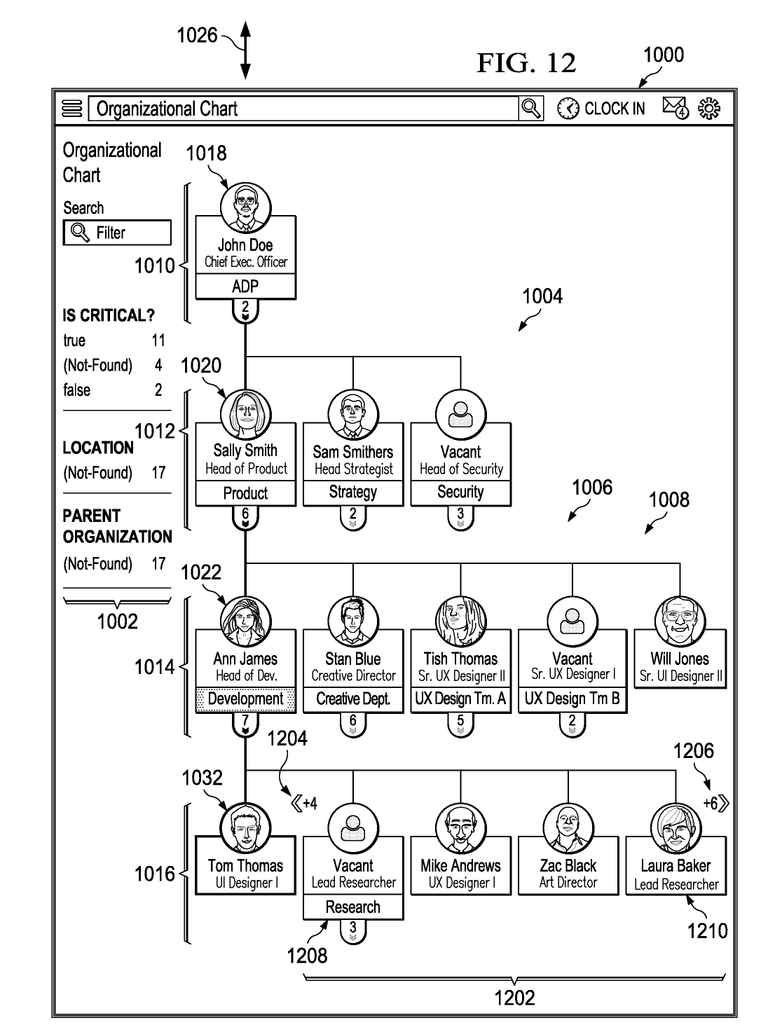

With reference now to FIG. 12, an illustration of graphical user interface 1000 from FIG. 11 is depicted in accordance with an illustrative embodiment. In this illustrative example, node 1032 has been aligned with left alignment axis 1026 in response to the selection of node 1032 in FIG. 11.

Further, set of nodes 1202 are displayed in graphical user interface 1000 for level 1016. Left expander control 1204 indicates that level 1016 includes four other nodes to the left not displayed in graphical user interface 1000. Right expander control 1206 indicates that level 1016 includes six other nodes to the right not displayed in graphical user interface 1000. Node 1208 is the leftmost node of set of nodes 1202 displayed. Node 1210 is the rightmost node of set of nodes 1202 displayed.

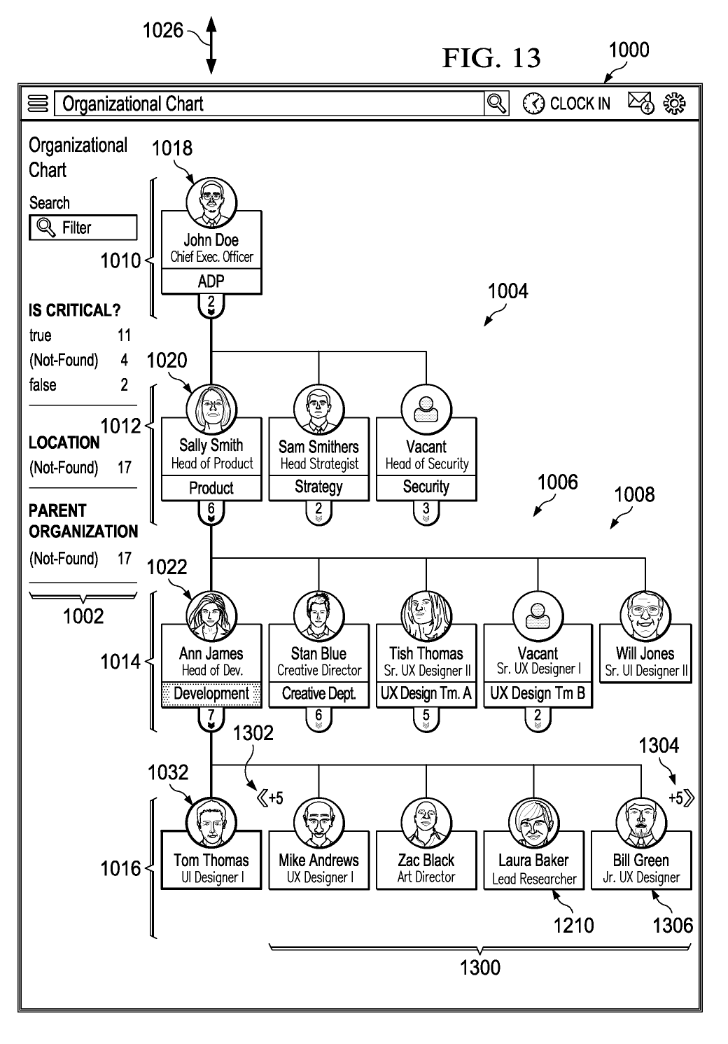

With reference now to FIG. 13, an illustration of graphical user interface 1000 from FIG. 12 is depicted in accordance with an illustrative embodiment. In this illustrative example, level 1016 has again been transformed based on the selection of right expander control 1206 in FIG. 12.

In particular, the selection of right expander control 1206 in FIG. 12 results in set of nodes 1300 being displayed in level 1016. The nodes displayed in level 1016 in FIG. 12 have shifted horizontally to the left. However, node 1032 is kept aligned with left alignment axis 1026.

Left expander control 1302 indicates that level 1016 now includes five other nodes to the left not displayed in graphical user interface 1000. Right expander control 1304 indicates that level 1016 now includes five other nodes to the right not displayed in graphical user interface 1000.

Set of nodes 1300 does not include node 1208 from FIG. 12 as the nodes of level 1016 have been visually shifted horizontally in graphical user interface 1000. New node 1306 is now the rightmost node displayed in level 1016.

The illustrations of graphical user interface 200 in FIGS. 2-9 and graphical user interface 1000 in FIGS. 10-13 are not meant to imply physical or architectural limitations to the manner in which an illustrative embodiment may be implemented. Other elements in addition to or in place of the ones illustrated may be used. Some elements may be optional.

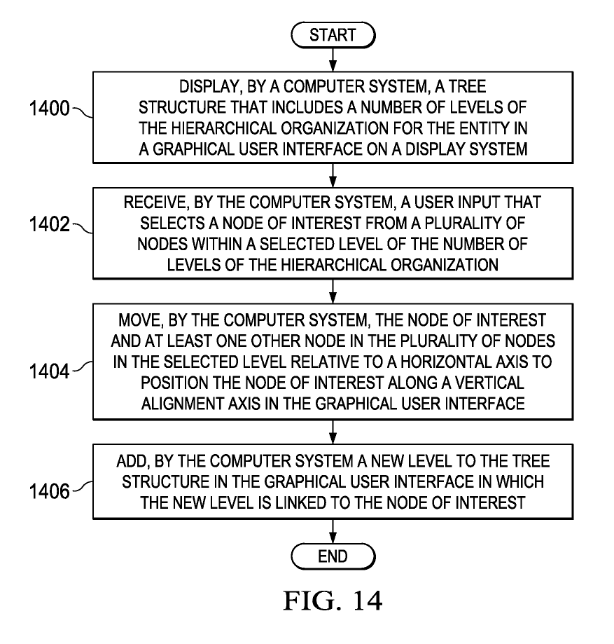

With reference now to FIG. 14, an illustration of a process for visually presenting a hierarchical organization for an entity is depicted in the form of a flowchart in accordance with an illustrative embodiment. The process illustrated in FIG. 14 may be implemented using entity management system 100 described in FIG. 1.

The process may begin by displaying, by a computer system, a tree structure that includes a number of levels of the hierarchical organization for the entity in a graphical user interface on a display system (operation 1400). Next, the computer system receives a user input that selects a node of interest from a plurality of nodes within a selected level of the number of levels of the hierarchical organization (operation 1402). In one illustrative example, this node of interest represents a position associated with the entity. For example, without limitation, when the entity is a business entity, the node of interest may represent a supervisor position.

Thereafter, the computer system moves the node of interest and at least one other node in the plurality of nodes in the selected level relative to a horizontal axis to position the node of interest along a vertical alignment axis in the graphical user interface (operation 1404). Further, the computer system adds a new level to the tree structure in the graphical user interface in which the new level is linked to the node of interest (operation 1406), with the process terminating thereafter. In one illustrative example, this new level includes one or more nodes that represent positions that are supervised by, or otherwise managed by, the supervisor position represented by the node of interest.

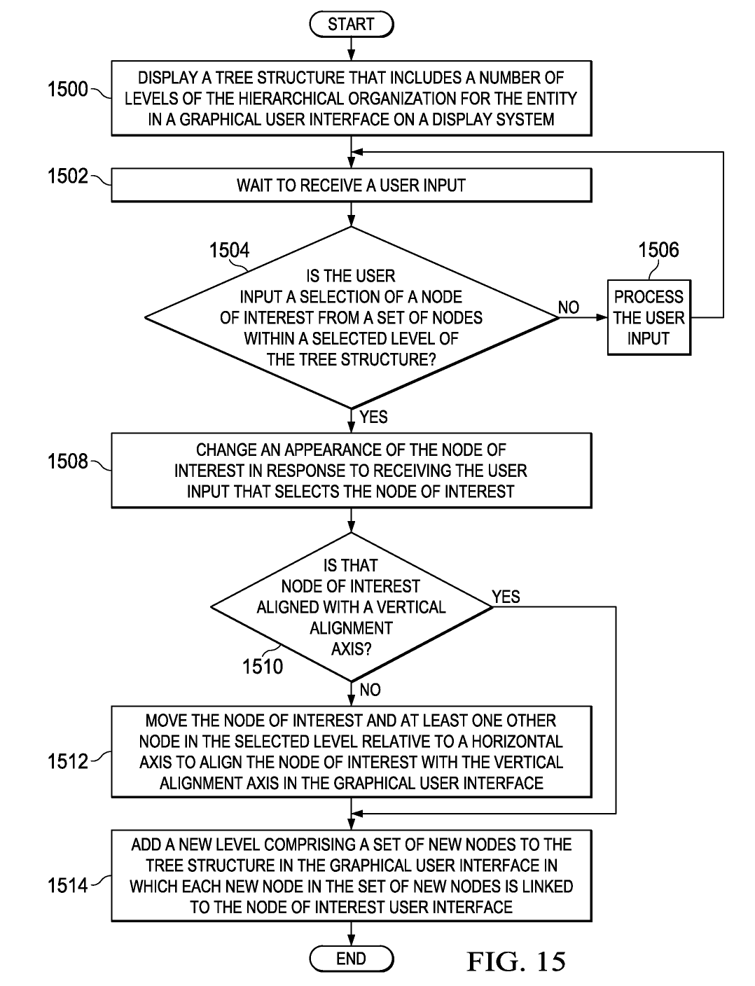

With reference now to FIG. 15, an illustration of a process for visually presenting a hierarchical organization for an entity is depicted in the form of a flowchart in accordance with an illustrative embodiment. The process illustrated in FIG. 15 may be implemented using entity management system 100 described in FIG. 1. In one illustrative example, each of the operations in the process illustrated in FIG. 15 may be implemented using organization manager 115 in computer system 116 in FIG. 1.

The process may begin by displaying a tree structure that includes a number of levels of the hierarchical organization for the entity in a graphical user interface on a display system (operation 1500). In some cases, operation 1500 is performed by displaying only a root level of the hierarchical organization for the entity in the graphical user interface on the display system in which the root level includes a root node. In other illustrative examples, operation 1500 includes displaying the root level and one or more other lower levels of the hierarchical organization.

Thereafter, the process waits to receive a user input (operation 1502). A determination is made as to whether the user input is a selection of a node of interest from a set of nodes within a selected level of the tree structure (operation 1504). If the user input is not a selection of a node of interest from a set of nodes within a selected level of the tree structure, the user input is processed (operation 1506), with the process then returning to operation 1502 described above.

However, with reference again to operation 1504, if the user input is a selection of a node of interest from a set of nodes within a selected level of the tree structure, an appearance of the node of interest is changed in response to receiving the user input that selects the node of interest (operation 1508). In operation 1508, the appearance of the node of interest may be changed by changing at least one of a background color, a font color, a highlight color, or some other graphical feature of at least a portion of the node of interest.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required.

For example, without limitation, “at least one of item A, item B, or item C” or “at least one of item A, item B, and item C” may mean item A; item A and item B; item B; item A, item B, and item C; item B and item C; or some other type of combination. In some cases, “at least one of item A, item B, or item C” or “at least one of item A, item B, and item C” may mean, but is not limited to, two of item A, one of item B, and ten of item C; four of item B and seven of item C; or some other suitable combination.

Thereafter, a determination is made as to whether that node of interest is aligned with a vertical alignment axis (operation 1510). In operation 1510, the vertical alignment axis may be a left alignment axis, a right alignment axis, or a center alignment axis that has been selected by the user. If the node of interest is not aligned with the vertical alignment axis, the node of interest and at least one other node in the selected level are moved relative to a horizontal axis to align the node of interest with the vertical alignment axis in the graphical user interface (operation 1512).

Thereafter, a new level comprising a set of new nodes is added to the tree structure in the graphical user interface in which each new node in the set of new nodes is linked to the node of interest (operation 1514). The process then returns to operation 1502 as described above. With reference again to operation 1510, if the node of interest is aligned with the vertical alignment axis, then the process proceeds to operation 1514 as described above.

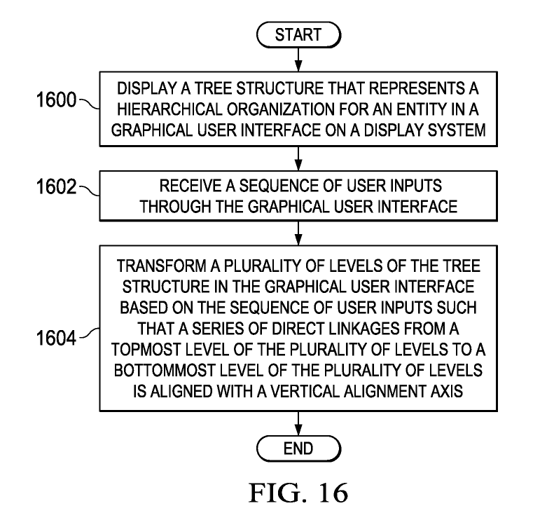

With reference now to FIG. 16, an illustration of a process for visually presenting a hierarchical organization for an entity is depicted in the form of a flowchart in accordance with an illustrative embodiment. The process illustrated in FIG. 16 may be implemented using entity management system 100 described in FIG. 1. In one illustrative example, each of the operations in the process illustrated in FIG. 16 may be implemented using organization manager 115 in computer system 116 in FIG. 1.

The process may begin by displaying a tree structure that represents a hierarchical organization for an entity in a graphical user interface on a display system (operation 1600). A sequence of user inputs is received through the graphical user interface (operation 1602). A plurality of levels of the tree structure in the graphical user interface are transformed based on the sequence of user inputs such that a series of direct linkages from a topmost level of the plurality of levels to a bottommost level of the plurality of levels is aligned with a vertical alignment axis (operation 1604), with the process terminating thereafter.

The alignment of the series of direct linkages with the vertical alignment axis may enable a user to more easily comprehend the relationships between the different nodes connected by these direct linkages. In particular, this type of alignment may enable the user to more quickly and more easily grasp the relationships between the different levels of the hierarchical organization for the entity.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent a module, a segment, a function, and/or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

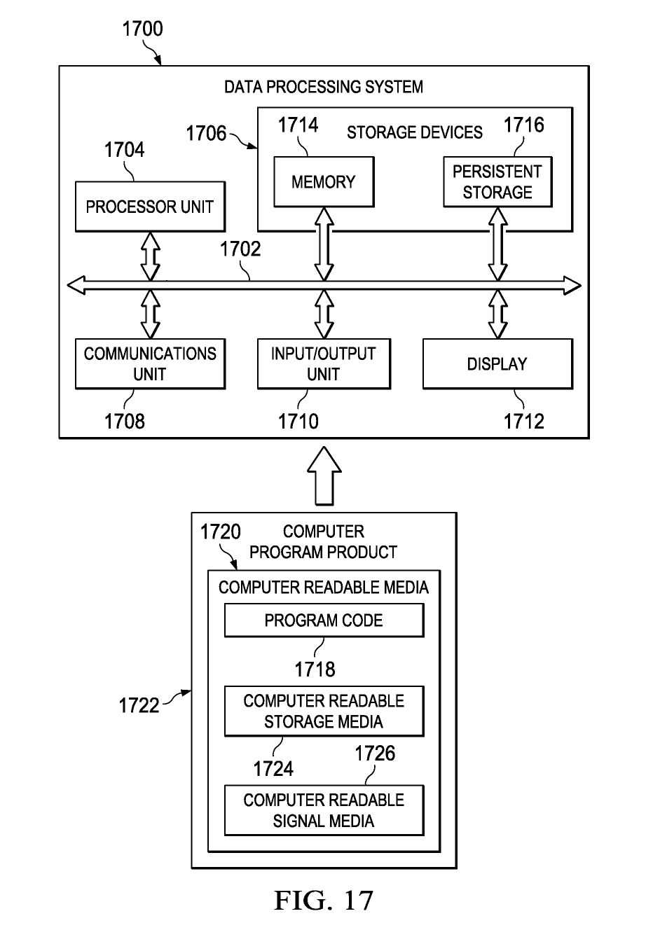

Turning now to FIG. 17, an illustration of a data processing system in the form of a block diagram is depicted in accordance with an illustrative embodiment. Data processing system 1700 may be used to implement computer system 116 in FIG. 1. As depicted, data processing system 1700 includes communications framework 1702, which provides communications between processor unit 1704, storage devices 1706, communications unit 1708, input/output unit 1710, and display 1712. In some cases, communications framework 1702 may be implemented as a bus system.

Processor unit 1704 is configured to execute instructions for software to perform a number of operations. Processor unit 1704 may comprise a number of processors, a multi-processor core, and/or some other type of processor, depending on the implementation. In some cases, processor unit 1704 may take the form of a hardware unit, such as a circuit system, an application specific integrated circuit (ASIC), a programmable logic device, or some other suitable type of hardware unit.

Instructions for the operating system, applications, and/or programs run by processor unit 1704 may be located in storage devices 1706. Storage devices 1706 may be in communication with processor unit 1704 through communications framework 1702. As used herein, a storage device, also referred to as a computer readable storage device, is any piece of hardware capable of storing information on a temporary and/or permanent basis. This information may include, but is not limited to, data, program code, and/or other information.

Memory 1714 and persistent storage 1716 are examples of storage devices 1706. Memory 1714 may take the form of, for example, a random access memory or some type of volatile or non-volatile storage device. Persistent storage 1716 may comprise any number of components or devices. For example, persistent storage 1716 may comprise a hard drive, a flash memory, a rewritable optical disk, a rewritable magnetic tape, or some combination of the above. The media used by persistent storage 1716 may or may not be removable.

Communications unit 1708 allows data processing system 1700 to communicate with other data processing systems and/or devices. Communications unit 1708 may provide communications using physical and/or wireless communications links.

Input/output unit 1710 allows input to be received from and output to be sent to other devices connected to data processing system 1700. For example, input/output unit 1710 may allow user input to be received through a keyboard, a mouse, and/or some other type of input device. As another example, input/output unit 1710 may allow output to be sent to a printer connected to data processing system 1700.

Display 1712 is configured to display information to a user. Display 1712 may comprise, for example, without limitation, a monitor, a touch screen, a laser display, a holographic display, a virtual display device, and/or some other type of display device.

In this illustrative example, the processes of the different illustrative embodiments may be performed by processor unit 1704 using computer-implemented instructions. These instructions may be referred to as program code, computer usable program code, or computer readable program code and may be read and executed by one or more processors in processor unit 1704.

In these examples, program code 1718 is located in a functional form on computer readable media 1720, which is selectively removable, and may be loaded onto or transferred to data processing system 1700 for execution by processor unit 1704. Program code 1718 and computer readable media 1720 together form computer program product 1722. In this illustrative example, computer readable media 1720 may be computer readable storage media 1724 or computer readable signal media 1726.

Computer readable storage media 1724 is a physical or tangible storage device used to store program code 1718 rather than a medium that propagates or transmits program code 1718. Computer readable storage media 1724 may be, for example, without limitation, an optical or magnetic disk or a persistent storage device that is connected to data processing system 1700.

Alternatively, program code 1718 may be transferred to data processing system 1700 using computer readable signal media 1726. Computer readable signal media 1726 may be, for example, a propagated data signal containing program code 1718. This data signal may be an electromagnetic signal, an optical signal, and/or some other type of signal that can be transmitted over physical and/or wireless communications links.

The illustration of data processing system 1700 in FIG. 17 is not meant to provide architectural limitations to the manner in which the illustrative embodiments may be implemented. The different illustrative embodiments may be implemented in a data processing system that includes components in addition to or in place of those illustrated for data processing system 1700. Further, components shown in FIG. 17 may be varied from the illustrative examples shown.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for visually presenting a hierarchical organization for an entity, the method comprising:
displaying, by a computer system, a tree structure that includes a number of levels of the hierarchical organization for the entity in a graphical user interface on a display system;
receiving, by the computer system, a user input that selects a node of interest from a plurality of nodes within a selected level of the number of levels of the hierarchical organization; and
moving, by the computer system, the node of interest and at least one other node in the plurality of nodes in the selected level relative to a horizontal axis to align the node of interest with a vertical alignment axis in the graphical user interface.

2. The method of claim 1, wherein displaying, by the computer system, the tree structure comprises:
displaying a root level of the hierarchical organization for the entity in the graphical user interface on the display system, wherein the root level includes a root node.

3. The method of claim 1, wherein moving, by the computer system, the node of interest and the at least one other node in the plurality of nodes comprises:
moving the node of interest in a left direction relative to the horizontal axis to align the node of interest with a left alignment axis.

4. The method of claim 1, wherein moving, by the computer system, the node of interest and the at least one other node in the plurality of nodes comprises:
moving the node of interest in a right direction relative to the horizontal axis to align the node of interest with a right alignment axis.

5. The method of claim 1, wherein moving, by the computer system, the node of interest and the at least one other node in the plurality of nodes comprises:
moving the node of interest in either a left direction or a right direction relative to the horizontal axis to align the node of interest with a center alignment axis.

6. The method of claim 1 further comprising:
adding, by the computer system, a new level to the tree structure in the graphical user interface in which the new level is linked to the node of interest.

7. The method of claim 6, wherein adding, by the computer system, the new level to the tree structure comprises:
displaying a set of new nodes horizontally to form the new level below the node of interest.

8. The method of claim 7, wherein adding, by the computer system, the new level to the tree structure further comprises:
displaying a direct linkage between the node of interest in the selected level and each new node of the set of new nodes in the new level.

9. The method of claim 6 further comprising:
receiving, by the computer system, another user input that selects a new node of interest from a set of new nodes in the new level of the hierarchical organization;
moving, by the computer system, the new node of interest relative to the horizontal axis to align the new node of interest with the vertical alignment axis in response to receiving the user input that selects the new node of interest; and
adding, by the computer system, an additional new level to the tree structure in which the additional new level is linked to the new node of interest in the new level.

10. The method of claim 1 further comprising:
changing, by the computer system, an appearance of the node of interest in response to receiving the user input that selects the node of interest.

11. The method of claim 10, wherein changing, by the computer system, the appearance of the node of interest comprises:
changing at least one of a background color, a font color, or a highlight color of at least a portion of the node of interest.

12. The method of claim 1, wherein displaying, by the computer system, the tree structure comprises:
displaying a set of nodes in a level of the tree structure in which at least one node in the set of nodes represents a position associated with the entity and includes an image of a person that currently holds the position, a name of the person, a title of the person, and a dependent number that identifies a number of positions that are supervised by the person.

13. The method of claim 12, wherein displaying the set of nodes in the level of the tree structure comprises:
displaying the set of nodes in the level of the tree structure in which at least one node in the set of nodes represents a vacant position associated with the entity.

14. The method of claim 1 further comprising:
displaying a set of new nodes horizontally below the node of interest to form a new level of the tree structure in the graphical user interface in which the new level is linked to the node of interest; and
displaying an expander control in the graphical user interface, wherein the expander control indicates that the new level includes at least one other new node in addition to the set of new nodes that are displayed in the graphical user interface.

15. The method of claim 14 further comprising:
receiving, by the computer system, another user input that selects the expander control through the graphical user interface;
removing, by the computer system, a portion of the set of new nodes currently displayed in the new level from the graphical user interface in response to receiving the user input; and
displaying, by the computer system, at least a portion of the at least one other new node in the new level in the graphical user interface.

16. A method for visually presenting a hierarchical organization for an entity, the method comprising:
displaying, by a computer system, a tree structure that represents the hierarchical organization for the entity in a graphical user interface on a display system;
receiving, by the computer system, a sequence of user inputs through the graphical user interface; and
transforming, by the computer system, a plurality of levels of the tree structure in the graphical user interface based on the sequence of user inputs such that a series of direct linkages from a topmost level of the plurality of levels to a bottommost level of the plurality of levels is aligned with a vertical alignment axis.

17. The method of claim 16, wherein transforming, by the computer system, the plurality of levels of the tree structure comprises:
moving a node of interest and at least one other node in a plurality of nodes in a selected level in the tree structure relative to a horizontal axis to align the node of interest with the vertical alignment axis in response to receiving a user input that selects the node of interest; and
adding a new level to the tree structure in the graphical user interface in which the new level is linked to the node of interest in the selected level.

18. The method of claim 17, wherein moving, by the computer system, the node of interest and the at least one other node in the plurality of nodes comprises:
moving the node of interest relative to the horizontal axis to align the node of interest with one of a left alignment axis, a right alignment axis, and a center alignment axis.

19. An apparatus comprising:
a display system that displays a graphical user interface; and
a computer system that displays a tree structure that includes a number of levels of a hierarchical organization for an entity in the graphical user interface on the display system; receives a user input that selects a node of interest from a plurality of nodes in a selected level of the number of levels of the hierarchical organization through the graphical user interface; and moves the node of interest and at least one other node in the plurality of nodes in the selected level relative to a horizontal axis to align the node of interest with a vertical alignment axis in the graphical user interface.

20. The apparatus of claim 19, wherein the vertical alignment axis is selected from one of a left alignment axis, a right alignment axis, and a center alignment axis.

21. The apparatus of claim 19, wherein the node of interest represents a position associated with the entity and includes an image of a person that currently holds the position, a name of the person, a title of the person, and a dependent number that identifies a number of positions that are supervised by the person.

22. The apparatus of claim 19, wherein the tree structure comprises:
a new level that is linked to the node of interest in the selected level, wherein the new level is added to the tree structure in the graphical user interface by the computer system.
